(19) United States
(12) Patent Application Publication
(10) Pub. No.: US 2012/0146915 A1
(43) Pub. Date: Jun. 14, 2012

(54) NOTEBOOK COMPUTER

(75) Inventor: QIANG CHEN, Shenzhen City (CN)

(73) Assignees: HON HAI PRECISION INDUSTRY CO., LTD., Taipei Hsien (TW); HONG FU JIN PRECISION INDUSTRY (ShenZhen) Co., LTD., Shenzhen City (CN)

(21) Appl. No.: 12/978,526

(22) Filed: Dec. 24, 2010

(30) Foreign Application Priority Data
Dec. 9, 2010 (CN) 201010580879.3

(51) Int. Cl. G06F 3/02

(52) U.S. Cl. 345/169

(57) ABSTRACT

A notebook computer includes a base and a keyboard detachably mounted to the base. The keyboard includes a control unit, a wireless transmitting module connected to the control unit, and a battery. The control unit is used to discern operations of the keyboard, and output corresponding signals according to the operations of the keyboard. The wireless transmitting module is used to receive the corresponding signals and converts the corresponding signals into wireless signals. The battery is used to power the control unit and the wireless transmitting module. The base includes a wireless receiving module and a motherboard. The wireless receiving module is used to receive the wireless signals, and converts the wireless signals into the corresponding signals. The motherboard is connected to the wireless receiving module to receive the corresponding signals to implement corresponding instructions according to the corresponding signals.

### BACKGROUND

1. Technical Field

The present disclosure relates to a notebook computer.

2. Description of Related Art

Notebook computers have keyboards fixed in position relative to the display screens. This fixed relationship can cause fatigue and/or discomfort to users over time.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an exploded, isometric view of an exemplary embodiment of a notebook computer; the notebook computer includes a base and a keyboard.

FIG. 2 is similar to FIG. 1, but showing an inverted view.

FIG. 3 is an assembled, isometric view of FIG. 1.

FIG. 4 is a block diagram of communications between the base the keyboard of FIG. 1.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

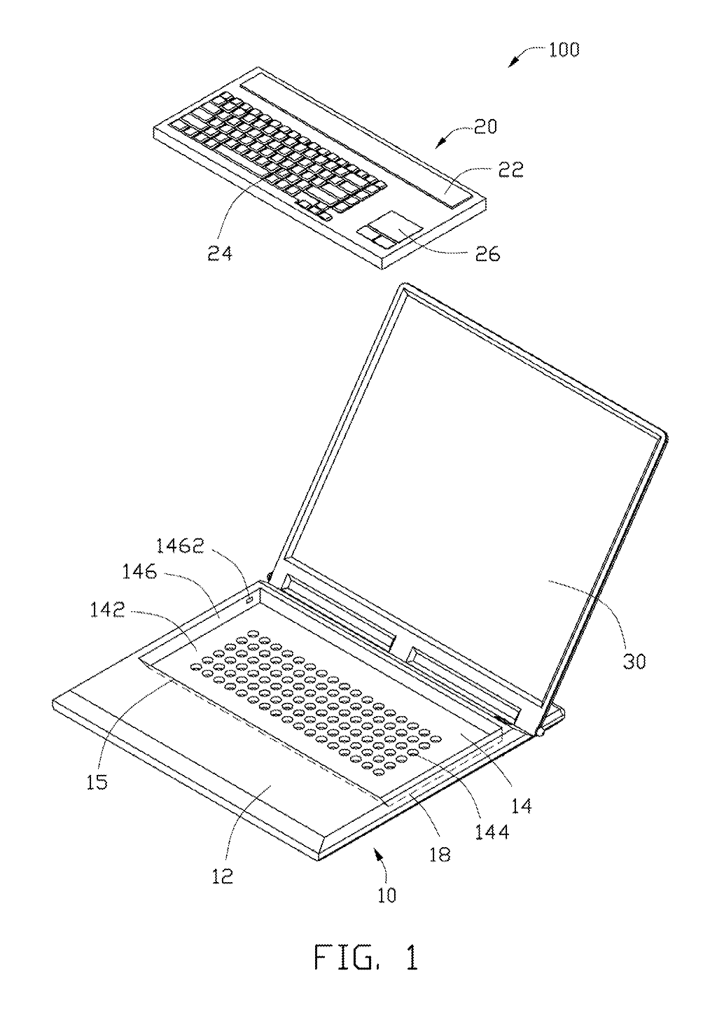

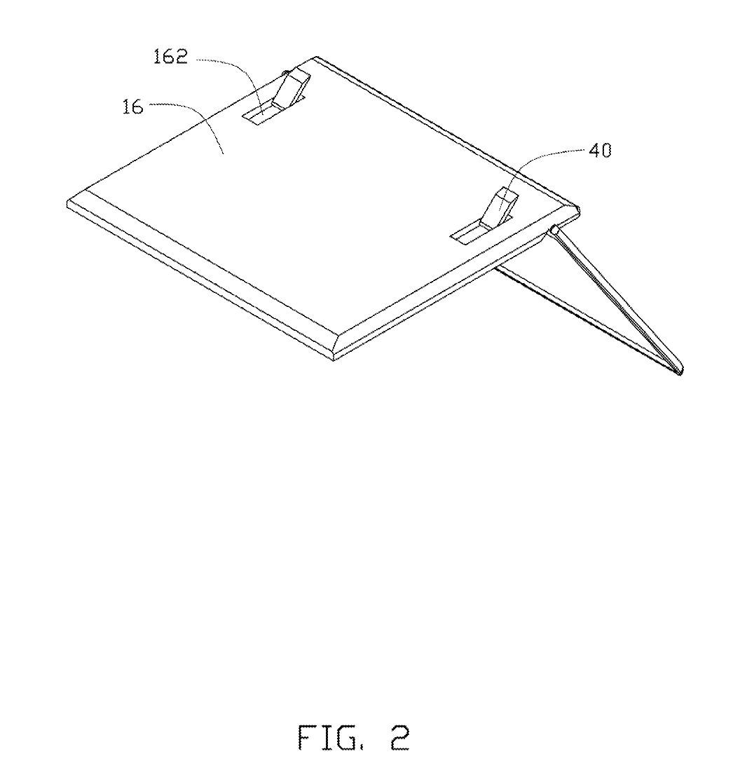

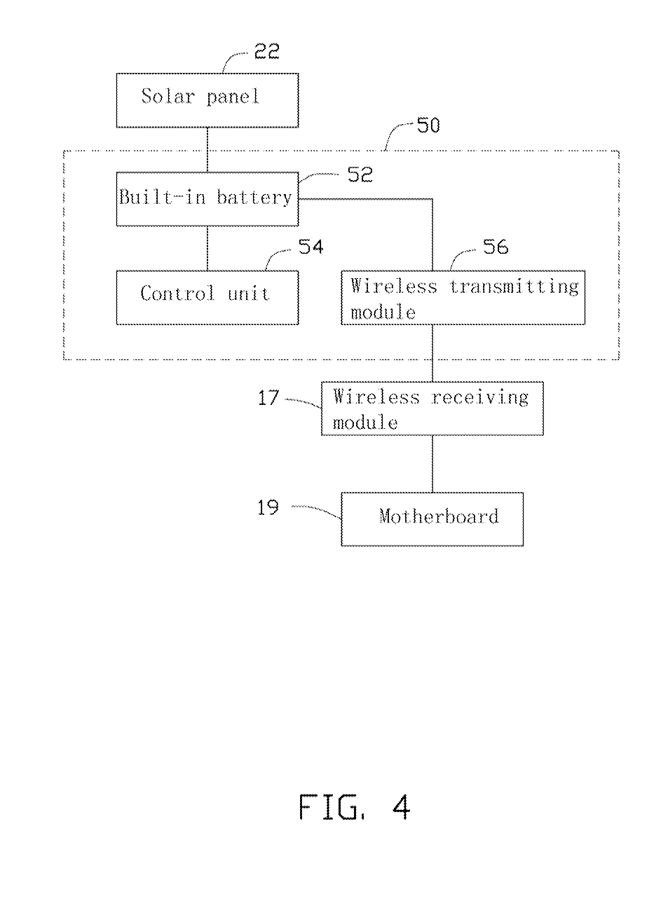

Referring to FIGS. 1 and 2, an exemplary embodiment of a notebook computer 100 includes a base 10, a keyboard 20, a screen 30 rotatably connected to the base 10, and two supporting elements 40. The base 10 includes an enclosure, a wireless receiving module 17 (shown in FIG. 4), and a motherboard 19 (shown in FIG. 4). The wireless receiving module 17 and the motherboard 19 are received in the enclosure. The enclosure includes a bottom wall 16, a top wall 12 opposite and substantially parallel to the bottom wall 16, and four sidewalls 18 substantially perpendicularly connected between sides of the bottom wall 16. A depression is formed in the top wall 12 to form a receiving recessreceiving recess 14 to receive the keyboard 20. A plurality of heat-dissipation holes 144 is defined in a bottom 142 of the receiving recess 14. Two elastic blocks 1462 respectively extend from opposite sidewalls 146 of the receiving recess 14. A front wall 15 of the receiving recess 144 is a slanted guiding surface with an obtuse angle formed between the front wall 15 and the bottom 142, to guide the keyboard 20 sliding into or out of the receiving recess 14. Two slots 162 are defined in opposite sides of the bottom wall 16 of the base 10. The supporting elements 40 are respectively rotatably engaged in the slots 162 to have the keyboard supported at an angle during use, the back of the base 10 is lifted, and the supporting elements 40 are rotated out of the corresponding slots 162 to support the base 10, thereby supporting the keyboard at an angle. Otherwise, the supporting elements are received in the corresponding slots 162

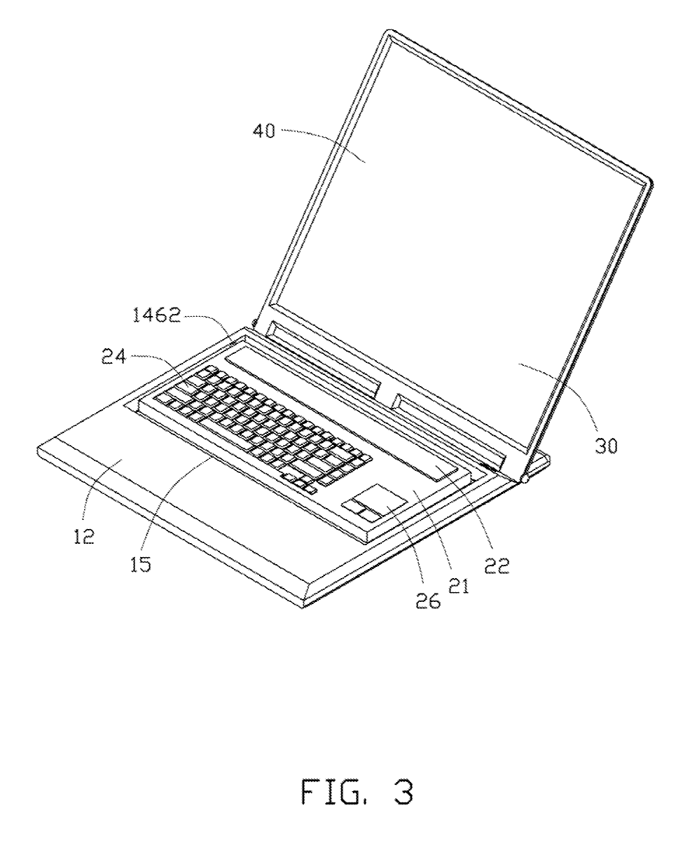

Referring to FIGS. 3 and 4, the keyboard 20 is a wireless keyboard. The keyboard 20 includes a case 21, a solar panel 22, a key area 24, a touch pad 26, and a keyboard control circuit 50. The solar panel 22, the key area 24, and the touch pad 26 are mounted on a top of the case 21. The keyboard control circuit 50 is arranged in the case 21. The keyboard control circuit 50 includes a built-in battery 52, a control unit 54, and a wireless transmitting module 56. The built-in battery 52 is connected to the solar panel 22. The solar panel 22 uses light energy to generate electrical energy to charge the built-in battery 52. The built-in battery 52 is connected to the control unit 54 and the wireless transmitting module 56 to power the control unit 54 and the wireless transmitting module 56. In the embodiment, the built-in battery is a built-in lithium battery.

In use, the keyboard 20 can be moved out of the receiving recess 14. When the keyboard is operated, the control unit 54 discerns pressing states of the keys of the keyboard 20, and transmits corresponding pulse signals according to the press states of the keys to the wireless transmitting module 56. The wireless transmitting module 56 receives the pulse signals and converts the pulse signals into wireless signals, and transmits the wireless signals. The wireless receiving module 18 receives the wireless signals and converts the wireless signals into the corresponding pulse signals, and transmits the corresponding pulse signals to the motherboard 19. The motherboard 19 implements corresponding instructions according to the received pulse signals, to realize communication between the motherboard 19 and the keyboard 20.

When the keyboard is not received in the receiving recess 20, the heat-dissipation holes 144 can help dissipate heat from the base 10.

When the notebook computer is not in use or to use the keyboard 20 in place, it is slid into the receiving recess 14 along the front wall 15. The blocks 1462 resist against the top of the keyboard 20 to keep the keyboard 20 sliding out of the receiving recess 14.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A notebook computer comprising:
a keyboard comprising:
a control unit to discern operations of the keyboard, and output corresponding signals according to the operations of the keyboard;
a wireless transmitting module connected to the control unit to receive the corresponding signals and converts the corresponding signals into wireless signals, and transmit the wireless signals; and
a battery to power the control unit and the wireless transmitting module; and
a base comprising:
a wireless receiving module to receive the wireless signals, and converts the wireless signals into the corresponding signals; and
a motherboard connected to the wireless receiving module to receive the corresponding signals to implement corresponding instructions according to the corresponding signals;
wherein the keyboard is detachably mounted on the base.

2. The notebook computer of claim 1, wherein the battery is a built-in battery, the keyboard further comprises a solar panel, the solar panel uses light energy to generate electrical energy to charge the built-in battery.

3. The notebook computer of claim 1, wherein the battery is a lithium battery.

4. The notebook computer of claim 1, wherein the base comprises a bottom wall, a top wall opposite to the bottom wall, and four sidewalls connected between sides of the bottom wall and the top wall, wherein the motherboard and the wireless receiving module are arranged among the top wall, the bottom wall, and the sidewalls, a top of the top wall is depressed to form a receiving recess to receive the keyboard.

5. The notebook computer of claim 4, wherein a plurality of heat-dissipation holes is defined in a bottom of the receiving recess.

6. The notebook computer of claim 4, wherein two blocks respectively extend from opposite sidewalls of the receiving recess to resist against the top of the keyboard in response to the keyboard being received in the receiving recess.

7. The notebook computer of claim 4, further comprising two supporting elements, wherein two slots are defined in opposite sides of a bottom of the bottom wall of the base, the supporting elements are rotatably mounted in the slots.
